(19) United States
(12) Patent Application Publication
(10) Pub. No.: US 2026/0161809 A1
(43) Pub. Date: Jun. 11, 2026

(54) METHOD AND SYSTEM FOR OPTIMIZATION OF DATA STORAGE

(71) Applicant: Sebolatito Adeyemi, Atlanta, GA (US)

(72) Inventor: Sebolatito Adeyemi, Atlanta, GA (US)

(21) Appl. No.: 18/977,368

(22) Filed: Dec. 11, 2024

Related U.S. Application Data
(60) Provisional application No. 63/589,438, filed on Oct. 11, 2023.

(51) Int. Cl. G06F 21/62; G06F 21/78

(52) U.S. Cl. CPC G06F 21/6209; G06F 21/78; H04L 9/50

(57) ABSTRACT

A system and method for data storage optimization is provided. The system and method can retrieve and mine one or more files from storage resulting in one or more data items related to the one or more files. The system and method perform analysis and classification of the one or more files based on the one or more data items. The system and method validate the classification based on rules and regulations. The system and method perform data storage operations based on the validated classification of the one or more files. Data Operations are stored to an immutable data structure for auditing and integrity.

### CROSS-REFERENCE TO RELATED APPLICATIONS

This application claims the benefit of priority of U.S. provisional application No. 63/589,438, filed Oct. 11, 2023, the entire contents of which are herein incorporated by reference.

### BACKGROUND OF THE INVENTION

The present invention relates to data storage and, more particularly, to a method and system for optimizing data storage through data deletion.

The modern world is built upon data. As such, keeping organized data stores and records is essential for organizations and people in general to operate and meet regulatory requirements. However, as the amount of data and records stored increases, the ability to keep track of individual files and determining which data needs to be kept or can be deleted becomes increasingly difficult. This leads to people and organizations keeping vast quantities of unnecessary data, that takes up valuable data storage space. This can cost money to continually add storage space, and cost labor and time to continually sift through the ever increasing mounds of data.

As can be seen, there is a need for a method and system that optimizes data storage by sifting through the vast quantities of data and determining what can or should be deleted. The present invention solves these issues by providing a method and system for identifying and deleting unnecessary data, thereby optimizing data storage. The present invention creates a workflow that automatically defines a process and method for how to identify and delete large datasets of unnecessary data. The present invention creates a trackable, auditable, defensible process for identifying, and removing/taking an action on a set of data.

### SUMMARY OF THE INVENTION

The system and method of the present invention consists of various interconnected components designed to autonomously manage data deletion across distributed storage environments. These components work together to map, analyze, classify, and delete data in compliance with current legal frameworks while maintaining audit trails and security protocols. The system and method can operate in both cloud-based and on-premises environments, providing flexibility for integration with existing IT infrastructures.

The components of the system and method of the present invention include: Automated Data Mapping allowing the system to scan and categorize data across multiple storage environments, providing visibility into stored information; Data Classification which can include a machine learning engine trained on historical datasets determines the retention, deletion eligibility, and legal status of data; Compliance Validation real-time rule engine integrated with regulatory databases, ensuring every deletion adheres to the latest regulatory requirements; Immutable Audit Trails allowing every data deletion action to be logged on an immutable blockchain ledger, providing tamper-proof records; Dynamic Compliance Updating wherein the system integrates new laws and amendments into its rule engine to ensure ongoing compliance; and Real-Time Deletion Certification where upon successful deletion, the system generates digitally signed certificates to validate the action.

### BRIEF DESCRIPTION OF THE DRAWINGS

FIG. 1 is a flow chart of a method of optimizing data storage, according to aspects of the present invention; and

FIG. 2 is a flow chart another method of optimizing data storage, according to aspects of the present invention.

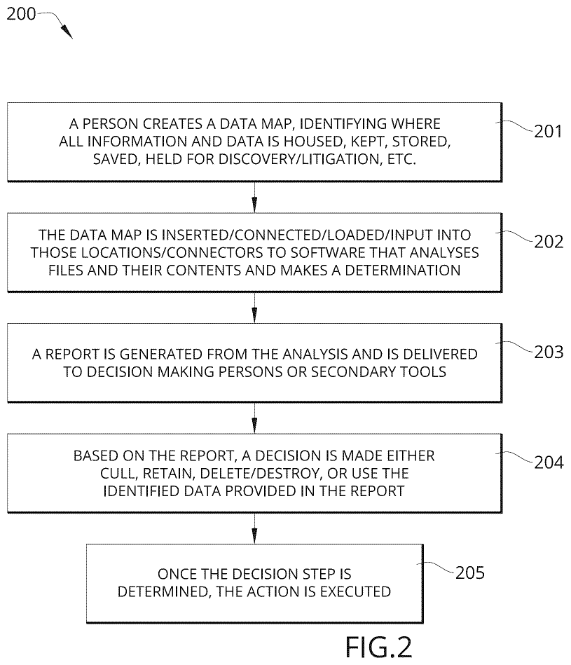

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The techniques of the present disclosure are illustrated as being implemented in a computing device such as a PC, laptop, tablet, smartphone or other device capable of executing computer-executed instructions stored on a non-transient medium, e.g., memory, such as RAM, ROM, EPROM, flash memory and so on. Thus, the execution of steps in a process flow is by way of computer-execution of such steps, e.g., via a processor configured to retrieve the corresponding instructions from memory and execute them.

The system and method of the present invention may include at least one computer with access provided thereto by a user interface. The computer may include at least one processing unit coupled to a form of memory. The computer may include, but is not limited to, a microprocessor, a server, a desktop, laptop, and smart device, such as, a tablet and smart phone. The computer includes a program product including a machine-readable program code for causing, when executed, the computer to perform steps. The program product may include systemic software which may either be loaded onto the computer or accessed by the computer. The loaded systemic software may include an application on a smart device. The systemic software may be accessed by the computer using a web browser. The computer may access the systemic software in part or entirely via the web browser using the internet, extranet, intranet, host server, internet cloud and the like.

Broadly, an embodiment of the present invention provides a method and system called Software as Solution to Hold/Delete (SASH). The method and system of the present invention include a data mapping functionality, whereby the method and system identify where all desired information and data is housed, kept, stored, or saved, both physically and digitally, e.g., on servers, the cloud, or on a particular hard drive, and the reason the data has been kept, e.g., held for e-discovery, litigation, general storage, business purposes, etc. The method and system then provide the data map and desired identified data to an analysis function that determines whether the desired identified data must be retained or can be deleted. The method and system of the present invention then create and provide a report based on the analysis to decision making persons or secondary tools, whereupon the system and method provide a means for the decision-making person or secondary tool to make a decision to cull or keep data based on the analysis and report produced by the method and system. Once the decision to cull or keep data is input into the method or system, the method or system may subsequently delete or retain the desired identified data.

By doing so the method and system of the present invention streamlines the process for identifying and deleting unnecessary data, thereby saving people and organizations time, money, and valuable data storage. The system provides for both automated and manual inputs so that checks and balances may be implemented to ensure data is properly retained or deleted.

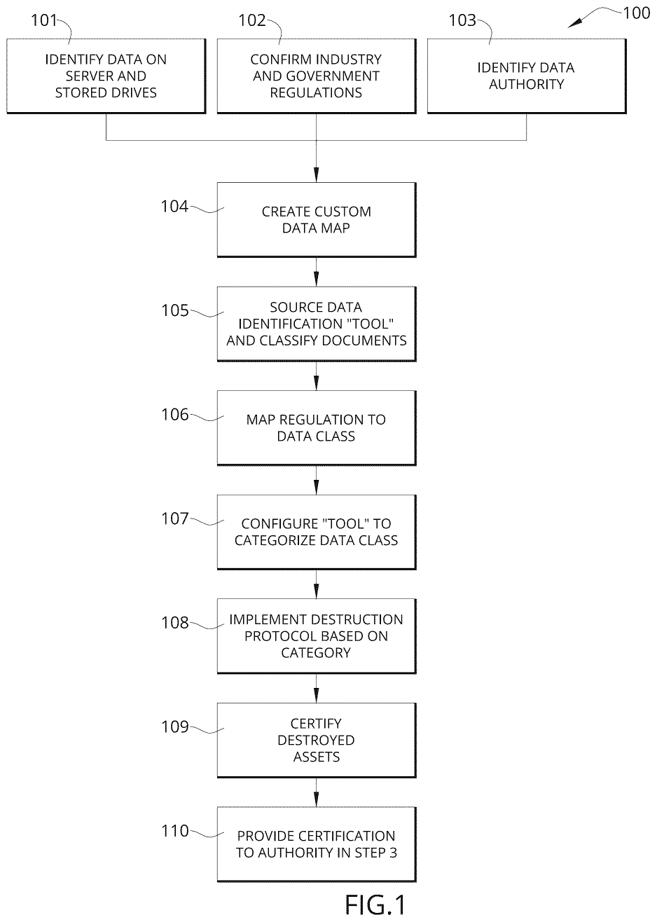

Referring now to FIG. 1, an embodiment of the method and system of the present invention is depicted. The method and system begin by identifying targeted data on a server, hard drive, or other storage device. In embodiments, one or more Data Mapping and Discovery Modules can start the process by deploying agents that scan all connected storage systems. These agents run independently of the central server to minimize latency and allow for asynchronous processing. These agents operate independently and use lightweight containers (e.g., Docker) to interface with storage APIs (e.g., AWS S3, Microsoft Azure Blob Storage, Google Cloud Storage) through secure connections. In embodiments, each agent utilizes a multi-threaded algorithm to scan directories and file systems in parallel. The system can traverse directory trees using recursive methods or perform batch API requests to collect metadata from cloud storage. Each thread handles different directories or parts of the storage, optimizing the speed of data discovery. In embodiments, extracted metadata includes creation date, last access time, owner, permissions, file type, and retention policy. Data can normalized using JSON-LD standards to ensure cross-platform compatibility and is stored in a centralized relational database for easy access by other modules.

Once the data is discovered, the Analysis and Classification Engine begins the classification process. The Analysis and Classification Engine analyzes the metadata provided by the discovery agents and, through its machine learning models, classifies the data according to compliance, risk, and relevancy. Data can be categorized into “retain”, “delete”, or “manual review” based on predefined rules and learned patterns. In embodiments, the Analysis and Classification Engine can utilize supervised learning models, such as XGBoost, to classify data based on metadata attributes like access frequency, ownership, and compliance requirements. Data can be categorized into “deletable”, “retain for legal reasons”, or “needs manual review”. In embodiments, the Analysis and Classification Engine can incorporate a continuous integration pipeline to retrain the model using newly collected data. Advantageously, this allows the model to adapt to evolving business processes and regulatory frameworks, ensuring that it remains effective over time.

The system and method then identify and confirm industry and government regulations associated with the targeted data. The system and method may then identify the data authority, e.g., regulatory body or owner, for the targeted data. In embodiments, a Compliance Management Engine steps in to ensure that the decisions made by the Analysis Engine adhere to local, national, and international regulations. This engine integrates directly with real-time regulatory databases, fetching the latest laws and rules governing data retention and deletion. Each data object's classification is validated against these laws. In embodiments, system uses a rule engine built on Drools to evaluate data against regulatory requirements. The rules engine continuously applies compliance regulations to the discovered data based on its metadata and compliance tags. Additionally, the system can integrate with external regulatory databases via RESTful APIs and webhooks, allowing it to receive real-time compliance updates. These updates are automatically applied to the system's rule engine to ensure compliance with the latest regulations.

Once the targeted data, regulations, and authority have been identified, the method and system create a data map for the targeted data. Thereafter, the system and method utilize an identification tool to identify contents of the targeted data and classify the contents. The method and system then map the classified content to associated regulations, and thereafter implement a configuration tool that categorizes data for deletion or retention. The categorized data is provided to a decision making person or secondary tool along with an interface for the decision making person or secondary tool to make a decision based upon the method and system's categorization of the data.

Once the decision has been made, the method and system may either allow the data to be retained or implement a data destruction protocol that follows the regulatory framework for deleting data as created by the relevant industry, government, or regulatory authority. Once the data destruction protocol is implemented and the data is destroyed, the method and system certify that the data assets were destroyed, and subsequently provides a data destruction certification to the previously identified relevant data authority.

The decisions validated by the Compliance Engine are executed by the Decision-Making Interface. In fully autonomous mode, data classified as “delete” is deleted immediately, while data marked for review is held for further manual verification. The interface also allows administrators to create specific workflows and policies based on organizational requirements. This enables customization of the automated decision-making process. In embodiments, the Decision-Making Interface can be a web-based dashboard built with React.js and powered by GraphQL APIs, but is not so limited. The decision making interface can provides administrators with granular control over the deletion process. In embodiments, the Decision-making Interface can include an Automated Dashboard configured to provide visual insights into data flagged for deletion, data under legal hold, and data requiring manual review. In embodiments, each deletion recommendation is presented with a confidence score generated by the machine learning model. Additionally, the Decision-making interface can include RBAC (role-based access controls) to control which users or services have access to specific data. Administrative actions, such as overriding a deletion, are logged and recorded for auditing purposes.

In embodiments, Every action taken by the system, from data discovery to deletion, is logged in the Audit and Certification Module. Using blockchain, all operations are cryptographically signed and stored in an immutable ledger. This audit trail is used to generate legally defensible certificates. In embodiments, the Audit and Certification Module can provides complete auditability and legal defensibility for all actions taken by the system. The Audit and certification module can include blockchain-based audit logs, wherein all data deletion actions are logged in an immutable ledger using Hyperledger Fabric. Advantageously, this ensures that every action—from discovery to deletion—is recorded securely and cannot be altered. Additionally, Audit and Certification Module can include digital certificates, wherein upon successful data deletion, the system generates a deletion certificate. In embodiments, these certificates can be cryptographically signed using SHA-256 encryption and stored alongside the blockchain ledger to provide verifiable proof of deletion.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the preceding describes a number of separate embodiments of the apparatus and method of the present invention, what has been described herein is merely illustrative of applying the principles of the present invention. Other arrangements, methods, modifications, and substitutions by one of ordinary skill in the art are therefore also considered within the scope of the present invention, which is not to be limited except by the claims directed to the present invention.

The computer-based data identification, deletion, and organization system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for data storage optimization, comprising:
At least one processor, and at least one memory, the memory having instructions that when executed cause the processor to perform a method, the method comprising:
retrieving, by at least one storage agent, at least one file from at least one storage system, the at least one file having at least one data item;
analyzing, by at least one analysis agent, the at least one data item;
based on the analysis, assigning at least one classification, by at least one classification agent, the at least one data item, wherein the at least one classification is one of: retain, delete, or manual review;
validating, by at least one validation agent, the at least one classification;
executing, based on the at least one classification, at least one operation one the at least one file; and
Logging the at least one operation to an immutable data structure.
